(19) United States
(12) Patent Application Publication
(10) Pub. No.: US 2017/0082021 A1
(43) Pub. Date: Mar. 23, 2017

(54) VARIABLE COMPRESSION RATIO PISTON MACHINE AND METHOD FOR ADJUSTING THE VARIABLE COMPRESSION RATIO PISTON MACHINE

(71) Applicant: FEV GmbH, Aachen (DE)

(72) Inventors: Uwe Schaffrath, Herzogenrath (DE); Paul Grzeschik, Aachen (DE)

(21) Appl. No.: 15/311,296

(22) PCT Filed: May 15, 2015
(86) PCT No.: PCT/EP2015/060760

§ 371 Date: Nov. 15, 2016

(30) Foreign Application Priority Data
May 15, 2014 (DE) 10 2014 007 052.2

(51) Int. Cl. F02B 75/04; F02D 15/02

(52) U.S. Cl. CPC F02B 75/045; F02D 15/02

(57) ABSTRACT

The present invention relates, in particular, to a variable compression ratio (VCR) piston machine comprising a crankshaft, at least one connecting rod, which is rotatably mounted on the crankshaft, wherein the connecting rod has a small bearing eye and a large bearing eye, and wherein the connecting rod has a connecting rod shaft, further comprising a compression piston, which is arranged on the connecting rod, preferably a combustion chamber piston which can be adjusted by means, for example, of an eccentric or some other adjusting element and of an adjustment system, preferably an adjustment linkage, wherein the adjustment system is supported by means of at least one support piston, which can be moved in a support cylinder of the connecting rod. A proposal is furthermore made for a method in which an adjustment accomplished by external forces acting on the adjustment system is supplemented or improved by additional adjustment forces.

### CROSS-REFERENCE TO RELATED APPLICATIONS

This application is a U.S. National Phase of PCT/EP2015/060760 filed May 15, 2015, which claims priority of German Patent Application 10 2014 007 052.2 filed May 15, 2014, the contents of which are herewith incorporated by reference into the subject matter of the present patent application

### FIELD OF THE INVENTION

The present invention relates to a reciprocating-piston machine having a reciprocating-piston internal combustion engine wherein engine oil pressure is used to modify the compression ratio.

### BACKGROUND

The present invention relates, in particular, to a variable compression ratio (VCR) piston machine comprising a crankshaft, at least one connecting rod, which is rotatably mounted on the crankshaft, wherein the connecting rod has a small bearing eye and a large bearing eye, and wherein the connecting rod has a connecting rod shaft, further comprising a compression piston, which is arranged on the connecting rod, preferably a combustion chamber piston which can be adjusted by means, for example, of an eccentric or some other adjusting element and of an adjustment system, preferably an adjustment linkage, wherein the adjustment system is supported by means of at least one support piston, which can be moved in a support cylinder of the connecting rod. A proposal is furthermore made for a method in which an adjustment accomplished by external forces acting on the adjustment system is supplemented or improved by additional adjustment forces.

There is a large number of different solutions in the prior art for changing the compression during the operation of a reciprocating-piston machine. Thus, in DE-A-10 2007 040 699, a magnetic solution is described. However, the invention starts instead from a piston machine of the kind known from DE-A-10 2005 055 199. The scope of the disclosure of the invention is defined with reference to the contents of this publication since this publication discloses the fundamental construction of the piston machine and of a possible special connecting rod that can be used. Thus, the contents of this document are incorporated by reference into the subject matter of the present patent application.

Further examples of reciprocating-piston machines with a variable compression ratio are known from DE-A-10 2012 107 868, DE-A-10 2011 108 790 and DE-A-10 2012 014 917. The last two documents relate to the triggering of the switching of the compression ratio by means of pressure pulses in the engine oil system, which are used to actuate a switch, without the use of an increased engine oil pressure in the subsequent adjustment of the compression ratio.

It is the object of the present invention to provide reliable modification of a stroke in a reciprocating-piston machine for various operating ranges.

### SUMMARY OF INVENTION

This object is achieved by means of a piston machine having the features of claim 1 and by means of a method having the features of claim 8. Further advantageous embodiments and developments will emerge from the subsequent dependent claims. However, the features which emerge from the individual dependent claims are not restricted to the individual embodiments. On the contrary, one or more features from the main claims and from the dependent claims can be made more specific or even replaced by one or more features from the following description. In particular, the present claims are not intended to restrict the invention. Moreover, one or more features from various embodiments can be combined to give further developments of the invention.

According to the embodiments of this invention, the engine oil pressure is increased briefly or for the duration of the adjustment in order to modify the compression ratio, that is to say not necessarily or not exclusively to trigger a modification of the compression ratio. When the compression ratio is adjusted from a lower to a higher value (a process involving increasing the effective length of the connecting rod), this leads to assistance for the inertia forces which “pull” on the compression piston at the top dead center of the latter when the stroke motion is reversed and which are used for this adjustment direction according to the prior art. By increasing the engine oil pressure, it is also possible, however, to achieve improved adjustment system performance when adjusting the compression ratio from a higher value to a lower value. During adjustment from a higher compression ratio to a lower compression ratio, the compression piston is acted upon by the gas forces, which are used to shorten the effective length of the connecting rod. These forces are very high, for which reason oil is “pumped around” at high speed from one support cylinder to the other. A similar situation is present when an adjustment system having a single support cylinder with a double-acting support piston is used. High oil pressures and high oil flow rates can lead to cavitation in the system, which is disadvantageous. In this phase of switching the adjustment system, therefore, there is usually an orifice in the oil discharge channel of the support cylinder supporting the gas forces, said orifice limiting the oil outflow rate to a maximum permissible value. This, in turn, is disadvantageous insofar as, when there is a need to switch from the higher compression ratio to a lower compression ratio at low loads and hence lower gas forces, this switchover process takes place relatively slowly. If the engine oil pressure and hence the pressure in the support cylinders can now be selectively increased, as envisaged according to the embodiment, the system can be braked at high loads, i.e. high gas forces, while using an orifice of relatively large dimensions, with the advantage that, by sacrificing this (backpressure) braking at low loads, switching over the compression ratio likewise takes place quickly. Thus, according to the embodiment, the selective increase in the oil pressure in the support cylinders is advantageous in both switchover directions of the compression ratio.

As a development of the embodiment, it is possible to envisage that, when required, the control unit activates the oil pump of the oil lubrication system in order to provide oil to be fed to the support cylinder at a pressure that is raised relative to the oil pressure currently required to supply the rotary bearing and/or the rotary bearings of the connecting rod, more specifically for the purpose of assisting the adjustment of the adjusting element out of the first adjustment position in the direction of and/or into the second adjustment position and/or for the purpose of damping or throttling the adjustment and/or the speed of adjustment of the adjusting element out of the second adjustment position in the direction of and/or into the first adjustment position.

It is furthermore advantageously possible to envisage that the oil pump can be activated by the control unit in order to increase the oil pressure for the purpose of assisting the adjustment of the adjusting element out of the first adjustment position in the direction of and/or into the second adjustment position, more specifically can be activated in a manner substantially independent of the oil pressure required, on the basis of the current operating mode, for lubricating and/or cooling the bearing or bearings of the connecting rod.

In particular, it can be advantageous that the oil pump can be activated by the control unit to increase the oil pressure for the purpose of throttling the speed of the adjustment of the adjusting element out of the second adjustment position in the direction of and/or into the first adjustment position when the operating mode is that of a part- or full-load mode at relatively low speeds of revolution or that of some other load mode which is close to the operating mode in which a lower compression ratio is sufficient or desirable or in which a switch to a lower compression ratio should take place.

Thus, according to the embodiment, it is envisaged that the adjustment of the compression ratio from a lower value to a higher value is always assisted by increasing the oil pressure in fundamentally all the operating modes of the reciprocating-piston machine. In the case of a reverse adjustment, this is not always the case or always required according to the embodiment. The oil pressure increase is required if relatively large gas forces are acting during the adjustment of the compression ratio from a high to a low value. In this case, the speed with which the oil emerges from the support cylinder provided to support the gas forces is then reduced by increasing the oil pressure in order to protect the system from the formation of cavities. If, on the other hand, relatively small gas forces are acting during the switchover from a high compression ratio to a lower compression ratio, braking of the adjusting movement is not absolutely necessary.

Further, according to a special development of the embodiment, a piston machine is proposed comprising a crankshaft, at least one connecting rod, which is rotatably mounted on the crankshaft and has a connecting rod shaft, a compression piston, which is arranged on the connecting rod, preferably a combustion chamber piston which can be adjusted, for example eccentrically, by means of an eccentric or more generally by means of an adjusting element and an adjustment system, preferably an adjustment linkage. The adjustment system is supported by means of at least one support piston which can be moved in a support cylinder of the connecting rod, wherein the connecting rod shaft has the support cylinder and wherein the support cylinder is connected to an oil lubrication system. The oil lubrication system has a controlled oil pressure variability in order to optimize an adjustment of the adjustment system on the basis of external forces.

It is further envisaged that the external forces, such as inertia forces and gas forces, are used for adjustment. In a first operating range, the stroke adjustment is preferably carried out exclusively with the aid of acting inertia forces and gas forces. In a second operating range of the piston machine, in contrast, adjustment is assisted by an increased oil pressure supplied to the at least one support cylinder.

Another embodiment envisages that the piston machine has one or more connecting rods, wherein, in the case of at least one connecting rod, the connecting rod shaft has a first and a second support cylinder and where the internal cross-sectional areas of the two support cylinders are different.

Another development of the embodiment envisages that the connecting rod shaft has a first and a second support cylinder, wherein the support piston in the second cylinder supports the inertia forces and the support piston in the first support cylinder supports the gas forces. The first support cylinder has a larger internal cross-sectional area than the second support cylinder.

Moreover, a piston machine is provided in which the adjustment system has a first and a second lever arm, wherein the first lever arm has a different length than the second lever arm. The two lever arms extend on both sides of the center of rotation of an adjusting element for moving the compression piston relative to the connecting rod.

A further development envisages that a first support cylinder and a second support cylinder are provided, wherein the first support cylinder supports the gas forces and the second support cylinder supports the inertia forces. The first support cylinder has a larger inside diameter than the second support cylinder. The adjustment system has a first lever arm and a second lever arm, wherein the first lever arm moves a first piston in the first support cylinder and the second lever arm moves a second piston in the second support cylinder. The second lever arm is shorter than the first lever arm.

The embodiment of the adjusting mechanism with two lever arms of different length in accordance with the above description is of independent inventive significance in the context of this patent application.

Moreover, it is also possible to envisage the provision in the oil lubrication system of an oil pump which ensures the variability of the oil pressure. More specifically, for selectively increasing the pressure in the first support cylinder when respectively acting external forces in the form of the gas forces or inertia forces are acting, or in the second cylinder for assisting the adjustment of the adjustment system due to the respectively acting external forces in the form of the gas forces or inertia forces.

It is also proposed that a control unit be provided which performs coordination of a pressure increase in the oil lubrication system at the time of adjustment of the stroke from low to higher compression and/or vice versa.

According to another object of the embodiment which may either independent or in combination with one or more other objects of the embodiment, a method for adjusting a stroke of a compression piston of a piston machine is proposed. Preferably of a piston machine as described above and/or below wherein an oil pressure is briefly increased by means of an adjustment system on a connecting rod of the compression piston in order to assist adjustment by acting external forces.

A development of the method envisages that a pressure increase is brought about in an oil lubrication system. More specifically in order to assist the inertia forces which are acting on the adjustment system or the compression piston and are used to adjust the stroke from low to higher compression and/or in order, when required, to accelerate the adjustment of the stroke from higher to lower compression, for which purpose gas forces are used.

Another embodiment of the method furthermore envisages that a pressure pulse is produced in the oil lubrication system. The pulse is selectively fed to the support cylinder for the purpose of actively adjusting the stroke from lower to higher compression and/or vice versa in which oil is “pumped around” out of the oil lubrication system for adjustment.

In a 2-stage or multistage VCR (variable compression ratio) system, the torques arising from the gas and inertia forces are supported by means of a support mechanism on the respective oil cushions situated in the support cylinders. In this regard, reference is made to the contents of DE-A-10 2013 021 065, which is incorporated by reference into the subject matter of the present patent application.

Adjustment is possible by means of the external forces which act as a torque on the eccentric or the compression piston adjusting element via the piston. For adjustment from a high to a low compression ratio, the gas forces are used. These lead to a relatively high torque on the eccentric or adjusting torque on the adjusting element, even at moderate loads, and therefore this switching direction can involve either additional assistance or no additional assistance. In the case of an adjustment from a low to a high compression ratio, in contrast, assistance in addition to the inertia forces which are supposed to “stretch” the connecting rod is preferred. This is because inertia forces act 1.) Only in a relatively short region of the stroke cycle, namely in the region of the reversal of the stroke motion at top dead center (TDC) of the compression piston (motion reversal TDC); and 2.) Are relatively low (<1 Nm on the eccentric) at low speeds (<1000 rpm). At low speeds, the torque level is scarcely above the breakaway torque of the VCR connecting rod. Very small differences in the friction, (for example the seals of the support pistons) can therefore have a great effect on the switching speed. Assistance by increasing the oil pressure raises the torque level for adjustment from a low to a high compression ratio in such a way that adjustment works reliably.

The support cylinders of the VCR connecting rod are preferably designed with different inside diameters. This is advantageous since the inertia forces to be supported are generally significantly lower than the gas forces. The differences in the piston diameter thus have a positive side effect—when there is an applied oil pressure from the crank pin bearing, there is an additional torque on the adjusting element, which turns the latter in the direction of a high compression ratio. This effect can be exploited, wherein one or more of the following aspects are preferably involved: 1.) Selection of different support piston diameters; 2.) The selection of different adjusting lever length on the adjusting element for the support of the gas and inertia force; 3.) Variability of the engine oil pressure; 4.) In the case of adjustment from a low to a high compression ratio at low speeds, for example <2000 rpm, a high engine oil pressure is selected, even if this is not actually necessary for bearing lubrication; and 5.) After adjustment, for example after approximately 1 second, the oil pressure can then be lowered again to the oil pressure required for reliable engine operation.

The combination of the kinematics (for example different support piston diameters and possibly different lever lengths) and increasing the engine oil pressure leads to an additional torque on the adjusting element. This comparable in terms of magnitude with the torque resulting from the inertia forces at low speeds. According to one embodiment, this additional torque furthermore acts throughout the entire cycle, not only at the motion reversal TDC. As a result, there is a significant reduction in switching times.

In addition, it is possible, by an appropriate choice of engine oil pressure and also for an adjustment from a high to a low compression ratio, to achieve a positive effect, as explained below.

Conventionally, an orifice is provided for this switching direction in the oil supply system to the support cylinders. This orifice being of such small dimensions that the system does not adjust too quickly for the highest possible peak pressure in the compression piston cylinder. Otherwise, there can be cavitation, for example, on the return valves associated with the respective support cylinders. If a switch is then required to the low compression ratio at relatively low loads (part-load mode of the reciprocating-piston machine), it would be advantageous if the dimensions of the orifice were larger, which would result in a permissible increase in the speed of adjustment of the system. It follows from this that a larger orifice will be chosen for the adjustment from a high to a low compression ratio and that the system will be “braked” by means of a brief increase in the engine oil pressure for the case of a higher load. Moreover, there is the possibility of using different orifices, for example using two different lines with different orifices or an adjustable orifice.

As a preferred option, a method is selected in which the engine oil pressure is adapted during an adjustment of the VCR connecting rod, in particular the engine oil pressure during an adjustment of the VCR connecting rod for adjustment from the low to the high compression ratio is increased at low engine speeds, and the engine oil pressure during an adjustment (for example a part-load mode) from the high to the low compression ratio is increased at high loads, for example high cylinder peak pressures.

### BRIEF DESCRIPTION OF DRAWINGS

Further advantageous embodiments and developments will become apparent from the following figures. However, the features emerging from the figures are not restricted to the individual embodiment. On the contrary, one or more features from one or more embodiments can be combined with one another or, alternatively, with features from the above general description to give further embodiments of the invention. The following embodiments thus serve for illustration of various possibilities and aspects of the invention without there being any intention to restrict them to these embodiments.

FIG. 1 illustrates a schematic view of a connecting rod with support cylinders, in which an increase in the oil pressure can be used to assist the external forces (inertia force or gas force) acting to adjust the stroke;

FIG. 2 illustrates another schematic view relating to the fundamental adjustment performed in the compression ratio in the operating ranges of the piston machine by means of the external forces;

FIG. 3 illustrates another schematic view of assistance to the external forces during the adjustment of the compression ratio by raising the oil pressure in both support cylinders;

FIG. 4 illustrates a circuit diagram of the hydraulic system during the adjustment of the compression ratio from a high to a low value; and

FIG. 5 illustrates a circuit diagram of the hydraulic system during the adjustment of the compression ratio from a low to a high value.

### DETAILED DESCRIPTION OF THE PREFERRED EMBODIMENTS

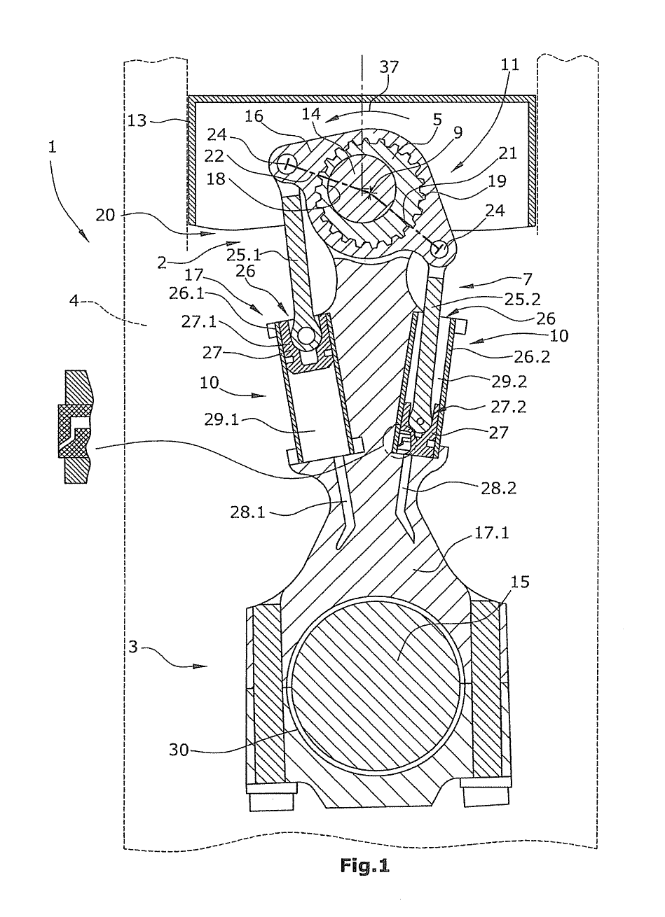

FIG. 1 illustrates an embodiment by means of which an adjustable change in a compression ratio is made possible in a piston machine 1 in the form of a reciprocating-piston internal combustion engine having a housing indicated at 4, wherein optionally at least one connecting rod 17 has a connecting rod shaft 17.1, on/in which two support cylinders 26 in the form of sleeves 26.1, 26.2 are secured. In this illustrative embodiment, the sleeves 26.1, 26.2 are press-fitted in the connecting rod shaft 17.1. In this illustrative embodiment, the sleeves 26.1, 26.2 for the support cylinders are produced from a different material than the connecting rod shaft 17.1. For example, the connecting rod shaft 17.1 is produced from a cast steel and the sleeves 26.1, 26.2 of the support cylinders are produced from aluminum.

The connecting rod 17 has a large connecting rod bearing eye 3, by means of which the connecting rod 17 is mounted on the crankshaft 15, and a small connecting rod bearing eye 2, which supports the compression piston 13 by means of a pin 14. Arranged in the small connecting rod bearing eye 2 there is, in turn, an eccentric 5, which is rotatably mounted. The eccentric 5 has a hole 18 to receive the piston pin 14. On its outer surface, the eccentric 5 has teeth 19. Via these teeth 19, the eccentric 5 is connected positively to a lever system 20, which acts as a support mechanism and preferably also as a detent. The lever system 20 has a pivoted lever 16, which is connected positively to the teeth 19 of the eccentric 5 and pivots the eccentric 5 when required. The pivoted lever 16 and the eccentric 5 form an adjusting element 11 for adjusting the compression piston 13. Viewed kinematically, the adjusting element 11 has two levers 21, 22, which extend from the center of rotation 9 of the adjusting element 11 and of which lever 22 is longer than lever 21. By means of its first lever 21 and the second lever 22, the pivoted lever 16 is supported on a support unit 7, as described below.

It can furthermore be seen from FIG. 1 that the lever system 20 is guided axially. Furthermore, the lever system 20 has connecting joints 24 between the pivoted lever 16 or on the two levers 21, 22 thereof. The connecting joints 24 are used to pivotally attach (piston) rods 25.1, 25.2. Support cylinder components 10 in the form, for example, of sleeves 26.1, 26.2, are, in turn, arranged as support cylinders 26 in the connecting rod shaft 17.1 of the connecting rod 17. Support pistons 27, to which the rods 25.1, 25.2 are respectively pivotally attached, are guided in the sleeves 26.1, 26.2. During a turning motion of the eccentric 5 caused and permitted by gas or inertia forces, the two support pistons 27.1, 27.2 move in the respective support cylinders 26 (sleeves 26.1, 26.2). The support cylinders 26 in the connecting rod 17 have channels 28.1, 28.2, which each lead to a working chamber 29.1, 29.2 in the sleeves 26.1, 26.2 (support cylinders 26). Connecting rod bearing shells 30 are arranged on the large connecting rod bearing eye 3. Since the bearing shells 30 are provided with a circumferential groove which is connected to an oil supply via the crankshaft, there is an oil pressure in the groove at all times. The sequence of motion during a modification of the compression ratio is furthermore available in greater detail from DE-A-10 2005 055 199, to which reference is made herewith and which is thus incorporated into the subject matter of the present patent application.

Assistance for an adjustment of the compression ratio caused by external forces can be taken from DE 10 2012 014 917 A1, for example, the contents of which are herewith incorporated by reference into the subject matter of the present application. In the solution proposed here, the pulsation described in DE 10 2012 014 917 A1 can be used to assist the gas force or inertia force.

The operation of the connecting rod 17 for setting a different compression ratio is explained below using the setting of a low compression ratio as an example. If a low compression ratio is desired during engine operation, a multiway valve is, for example, set to a position in which the two channels for the outflow of oil into working chamber 29.1 and for the inflow of oil into the other working chamber 29.2 are open. In those engine phases in which gas pressure forces act on the connecting rod 17 owing to combustion and said connecting rod moves in the direction of the crankshaft (i.e. downward), support piston 27.1 is pushed further into sleeve 26.1, with the result that the oil situated in the first working chamber 29.1 is displaced into channel 28.1. At the same time, support piston 27.2 moves and draws oil into the second working chamber 29.2 via channel 28.2. Thus, the eccentric 5 can turn stepwise in the direction of arrow 37 in FIG. 1. This opposed movement of the two support pistons 27.1, 27.2 is automatically ended when the stroke motion of the connecting rod 17 is reversed and the connecting rod moves upward again. Now, the second support piston 27.2 is acted upon by a force resulting from the inertia of the “accelerated” mass of the compression piston, of the eccentric 5 and of the lever system 20. Since channel 28.2 is not open (the valve, not shown, is closed), support piston 27.2 is supported on the oil volume in working chamber 29.2. It is not possible for the eccentric 5 to turn in the opposite direction since the first working chamber 29.1 is closed and the first support piston 27.1 cannot plunge into it.

Upon the next reversal of the connecting rod motion, the inertia force “pulls” on the second support piston 27.2, with the result that oil could enter working chamber 29.2 again. At the same time, the first support piston 27.1 displaces oil from working chamber 29.1. This stepwise opposed motion of the two support pistons 27.1, 27.2 may thus lead, over a number of working cycles of the piston machine, to the eccentric rotating out of one rotational end position. One of the two support pistons 27 is at the bottom of the associated support cylinder 26 while the other support piston is at a distance from the bottom of “its” support cylinder and into the other rotational end position. The situation with regards to the respective position occupied by the support piston is precisely the reverse of that described above.

To adjust the compression ratio from a lower value to a higher value, it is ensured that adjustment of the lever system 20 and hence rotation of the eccentric counter to the arrow 37 in FIG. 1 in the direction of the eccentric position shown there takes place only when support piston 27.2 is being “pulled” (this being the case owing to inertia at the beginning of the downward motion of the compression piston to draw air into the combustion chamber). Depending on the design of one or more hydraulic resistances and a magnitude of the drive train forces, a piston plunging process can take several working cycles. The hydraulic resistance is preferably formed by a connecting line or by a restriction situated therein.

This embodiment of a method is purely illustrative, as is the construction of the connecting rod, and not restrictive. The support pistons used have a defined leakage path, which is here made possible in the form of a special seal design of a sealing element, shown on an enlarged scale in relation to the first support piston 27.1.

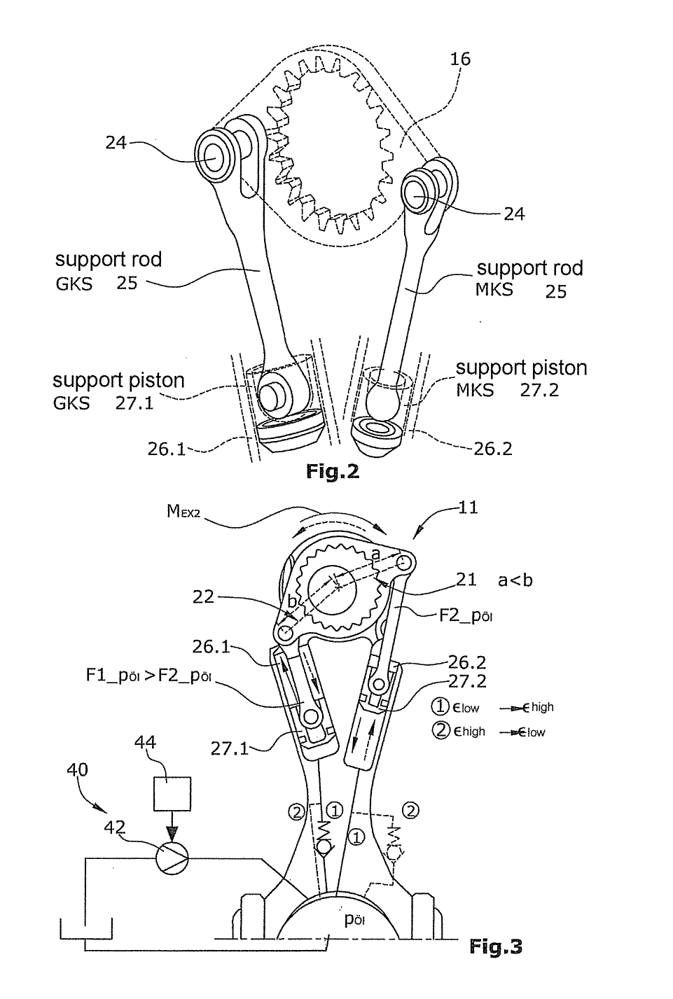

FIG. 2 shows as an illustrative embodiment, an at least 2-stage VCR system based on the principle of a variable connecting rod length. This principle represents the main possibility of adjustment which is used according to the embodiment. For this purpose, an eccentric for receiving the piston pin is pivotably mounted in the small connecting rod bearing eye. The gas and inertia forces acting on the piston lead to a torque acting on the eccentric. A support mechanism having a lever, two support rods and two support pistons is connected to the eccentric and transmits this torque to two support cylinders inserted in the connecting rod. The support cylinder facing in the direction of eccentricity, such as the one of the two support cylinders which is further away from the center of rotation of the eccentric, assumes the support of the torques resulting from the gas forces. The other support cylinder assumes the support of the inertia forces in an equivalent manner. The two sides of the connecting rod are therefore referred to below as the “GFS” (gas force side) and the “IFS” (inertia force side). Both support cylinders can be filled with oil when required. A check valve associated with each support cylinder allows the intermittent inflow of oil and prevents oil outflow and vice versa. The GFS and the IFS can be selectively opened by means of a 3/2-way switching valve as a non-limiting example. This combination of check valves and switching valves forms a hydraulic freewheel wherein the running direction of which is selectable. In the case where a high compression ratio, also referred to as “ε_high”, is the selected position. The torques acting on the eccentric, which are mathematically positive, are supported on the oil column of the GFS. In this position, the torques arising from the inertia forces, which have a mathematically negative effect, are transmitted by direct metallic contact between the IFS support piston and the connecting rod. In the position for a low compression ratio, abbreviated to “ε_low”, the situation is reversed. A positive side effect of the “ε_low” position is that the gas forces, which are normally higher in this position, are now no longer supported on the oil column and therefore the oil pressure in the support cylinder remains at a relatively low level. The adjustment system of the support system of this kind is thus provided with a first and a second support piston wherein the two support pistons have different connections to the respective support rod. One support piston, which has a ball-headed joint, has a smaller support piston diameter than the other support piston, which has a pin joint. The lever transmits to the support rods the torque resulting from the eccentricity, which can be more than 300 Nm owing to the ever-increasing combustion peak pressures of modern highly charged spark-ignition engines. The leverage resulting from the ratio between the eccentricity and the lever length is approximately 1/10, for example. In conjunction with the angle of attack of the force between the support rods and the lever, which is dependent on the respective ε position, supporting forces which can quite easily be up to 10 kN are thus obtained. The preferred type of joint at the lever is a traditional pin. This is connected in a fixed manner to a fork-shaped structure at the upper end of the support rods and supported in the lever. The surface pressures which occur here are up to 200 MPa, for example. The joint at the support pistons can likewise be embodied as a pin bearing. The other preferred embodiment provides a ball joint. On the one hand, this allows a smaller support piston diameter, which has two positive side effects for the IFS, the forces of which are significantly lower than on the GFS. In this embodiment the connecting rod is lighter since the structure around the support cylinder can be remodeled accordingly. By means of an IFS support piston diameter which is as small as possible, a small but continuously acting torque on the eccentric in the direction of ε_high is obtained owing to the oil pressure. At low engine speeds, this has a favorable effect on the switching behavior since, in this case, the torques resulting from the inertia forces, which are necessary for adjustment, are correspondingly low. On the other hand, the elimination of a pin allows the exploitation of the entire height of the support piston as a sealing length. This is advantageous as regards the elimination of additional sealing elements since, although the system can tolerate a certain leakage for example at a leverage of about 1/10, leakage-induced sagging of the support piston of for example, 0.1 mm affects the effective connecting rod length by only about 10 μm. Therefore, the compression ratio can “drift” in an unwanted manner if it is too great. The sealing elements likewise produce an additional friction torque during an adjustment process. Thus, an adjustment can only be initiated if this torque is overcome. The sealing element can thus also comprise a sealing system consisting of an O-ring and a rectangular-section ring situated above the latter and composed of a PTFE composite material. The friction thereof results in a breakaway torque of the eccentric of 0.5 Nm to 0.8 Nm, for example. However, this apparently low torque level is only slightly exceeded at low speeds for switching in the “ε_high” direction because the inertia forces at these operating points are likewise very low. Since, in turn, an excess torque which is only small is associated with losses of switching speed, the abovementioned measures are therefore highly significant at these extreme operating points.

FIG. 3 illustrates another schematic view of the assistance of the acting external forces based on increasing the oil pressure in one of the adjusting cylinders. In this regard, reference is made particularly to the contents of German Patent Application 10 2014 004 987.6 of Apr. 7, 2014 and of PCT Application PCT/EP2015/057474 of Apr. 7, 2015, the contents of which are incorporated by reference into the subject matter of the present patent application.

FIG. 3 illustrates the hydraulic system used in accordance with the embodiment for assisting or braking the adjustment of the compression piston adjusting element 11 in FIG. 1. This hydraulic system is ultimately the oil lubrication and cooling system 40 of the reciprocating-piston machine, which supplies the connecting rod bearings and the crankshaft bearings with oil. FIG. 3 illustrates schematically that this oil lubrication system 40 has an oil pump 42, which can be activated by means of a control unit 44 in order to supply the respective oil pressure required to operate the reciprocating-piston machine. Oil is supplied to the support and adjustment influencing unit 7 of FIG. 1 such as to the support cylinders 26, through various lines or channels in the connecting rod, which end in the crankshaft bearing eye of the connecting rod or discharge there.

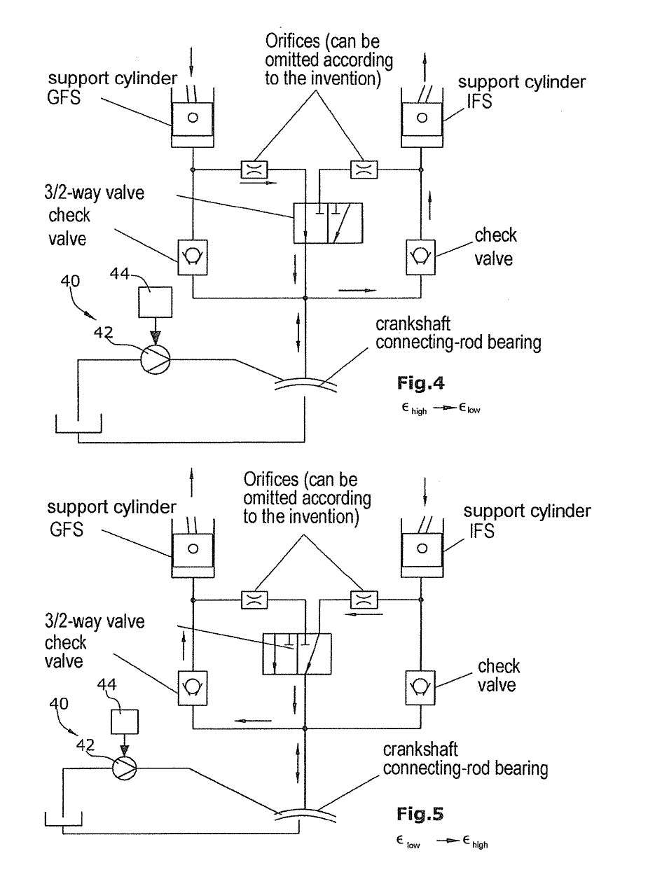

The conditions during the adjustment of the compression ratio from ε_{low} to ε_{high} are shown in FIG. 3 at (I) (and also as a circuit diagram in FIG. 5), while the adjustment from ε_{high} to ε_{low} is shown in FIG. 3 at (I) (and also as a circuit diagram in FIG. 4). The respective movements which are obtained in the two situations, together with the corresponding directions, are indicated by solid arrows for situation (I) and by dashed arrows for situation (I) in FIG. 3.

A brief increase in the engine oil pressure beyond the level which is currently required for lubricating and/or cooling the bearings of the reciprocating-piston machine assists the extension of support piston 27.1 out of the support cylinder 26.1 associated therewith in state \textcircled{1} (see also FIG. 2). During this process, the increased engine pressure has no effect on support cylinder 26.2 (see also FIG. 5).

If there is to be a switch from a high compression ratio to a low compression ratio (see situation \textcircled{2} in FIG. 3 and FIG. 4), it is possible, when there are large gas forces in this state, for excessively rapid outflow of oil from support cylinder 26.1 retardation or slowing of the flow rate can be achieved through the buildup of a backpressure in the oil lubrication system 40 owing to a pressure increase. This normally being achieved previously by means of orifices or similar restriction elements, which it is thus possible to eliminate according to the embodiment herein. This has the advantage that there is no such orifice to limit the flow rate at relatively small gas forces during the changeover from a high to a lower compression ratio, and thus higher switching speeds are obtained in this phase than in the prior art.

The embodiment has been described above by means of an illustrative embodiment in which the connecting rod has two support cylinders with support pistons associated therewith. However, it is also likewise conceivable to implement the embodiment on a connecting rod which has just one single support cylinder with two working chambers and a double-acting support piston between the working chambers. It is likewise not absolutely essential to the embodiment that the support cylinders, as shown in FIG. 1, should be implemented by separate components mounted on the shaft of the support piston. The manner of an embodiment of the support pistons is entirely immaterial to the invention. In particular, the embodiment can also be used to adjust compression pistons on connecting rods, wherein the connecting rod has integrally formed support cylinders or at least one integrally formed support cylinder. Moreover, the embodiment is not restricted to the eccentric adjustment of a compression piston relative to the connecting rod thereof. Other adjustment mechanisms are likewise possible and can be implemented within the scope of the embodiments. The embodiment is to be seen primarily in the special variation of the oil pressure to assist or brake the adjustment of the compression ratio from a first position to a second position.

As an alternative, the embodiment can furthermore be described by one of the following groups of features, wherein the groups of features can be combined with one another as desired and individual features of a group of features can also be combined with one or more features of one or more other groups of features and/or one or more of the embodiments described above.

A piston machine comprising a crankshaft, at least one connecting rod (17), which rotates together with the crankshaft, wherein the connecting rod (17) has a small bearing eye (2) and a large bearing eye (3), and wherein the connecting rod (17) has a connecting rod shaft (17.1), a compression piston, which is arranged on the connecting rod (17), preferably a combustion chamber piston which can be adjusted eccentrically by means of an eccentric (5) and an adjustment system, preferably an adjustment linkage, wherein the adjustment system is supported by means of at least one support piston (27, 27.1, 27.2), which can be moved in a support cylinder of the connecting rod (17), wherein the connecting rod shaft (17.1) has the support cylinder, wherein the support cylinder is connected to an oil lubrication system, and the oil lubrication system the oil pressure for the purpose of assisting the adjustment of the adjustment system, taking place per se owing to acting external forces, from a lower to a higher compression ratio and/or, when required, for damped slowing of an adjustment from a higher to a lower compression ratio.

The piston machine according to the above, wherein the connecting rod shaft has a first and a second support cylinder, wherein the internal cross-sectional area of the first support cylinder is different from that of the second support cylinder, wherein the oil pressure is increased when adjusting the adjustment system.

The piston machine according to the above, wherein the connecting rod shaft has a first and a second support cylinder, wherein the second support cylinder supports inertia forces and has a smaller internal cross-sectional area than the first support cylinder, which supports gas forces.

The piston machine according to the above, wherein the adjustment system has a first and a second lever arm, wherein the first lever arm has a different length than the second lever arm.

The piston machine according to the above, wherein a first support cylinder and a second support cylinder are provided, wherein the first support cylinder supports gas forces and the second support cylinder supports inertia forces, wherein the first support cylinder has a larger internal cross-sectional area than the second support cylinder, and wherein the adjustment system has a first lever 22 and a second lever 20, wherein the first lever 22 moves a first piston 27.1 in the first support cylinder (26) and the second lever 20 moves a second piston 27.2 in the second support cylinder 26, and the second lever 20 is shorter than the first lever 22.

The piston machine according to the above, wherein an oil pump is provided in the oil lubrication system, which ensures the variability of the oil pressure when required in order to increase the pressure for the purpose of slowing the transfer of the adjusting element 11 out of the second in the direction of and/or into the first adjustment position when the gas forces are acting on the support piston 27.1 in the first support cylinder 26, or constantly ensures said pressure in order to transfer the adjusting element 11 out of the second in the direction of and/or into the first adjustment position assist the inertia forces in the adjustment of the adjusting element out of the first adjustment position thereof in the direction of and/or into the second adjustment position.

The piston machine according to the above, wherein a control unit is provided, which performs coordination of a pressure increase in the oil lubrication system for adjustment of the stroke from low to higher compression.

A method for adjusting a stroke of a compression piston of a piston machine, preferably a piston machine according to the above, by means of an adjustment system on a connecting rod of the compression piston, wherein the oil pressure in the two support cylinders of the adjustment system is briefly increased in order to assist and/or accelerate the adjustment of the compression piston relative to the connecting rod.

The method according to the above, wherein an increase in the pressure of oil in an oil lubrication system is brought about in order to assist inertia forces which are acting for adjustment from a low to a high compression behavior or in order to accelerate an adjustment from a high to a low compression ratio taking place on the basis of gas forces.

The method according to the above, wherein the pressure increase in the oil lubrication system is accomplished by means of one or more pressure pulses.

### LIST OF REFERENCE SIGNS

1 piston machine
2 small connecting rod bearing eye
3 large connecting rod bearing eye
5 eccentric
7 support unit
9 center of rotation
10 support cylinder component
11 adjusting element for the compression piston
13 compression piston
14 piston pin
15 crankshaft
16 pivoted lever
17 connecting rod
17.1 connecting rod shaft
18 hole
19 teeth
20 lever system or adjustment mechanism
21 first lever
22 second lever
24 connecting joints
25 rods
26 support cylinder
26.1 sleeve as support cylinder
26.2 sleeve as support cylinder
27 support piston
27.1 support piston
27.2 support piston
28 channel
28.1 channel
28.2 channel
29 working chamber
29.1 working chamber
29.2 working chamber
30 connecting rod bearing shells
37 arrow
40 oil lubrication and cooling system
42 oil pump
44 control unit

1. A reciprocating-piston machine having a reciprocating-piston internal combustion engine which may be operated with a variable compression ratio and may be operated in various operating modes such as part load and full load, comprising:
a housing;
a rotatably mounted crankshaft arranged in the housing;
at least one connecting rod having a first end and a second end, the first end having a rotary bearing for the rotatable mounting of the connecting rod on the crankshaft;
a compression piston rotatably mounted on the second end of the connecting rod, the second end is opposite the first end of the connecting rod and can be adjusted relative to the connecting rod;
an adjustment mechanism for adjusting the compression piston relative to the second end of the connecting rod for the purpose of changing the compression ratio;
the adjustment mechanism has an adjusting element coupled to the compression piston, and at least one support- and adjustment influencing unit for selectively supporting or locking the adjusting element, said unit having at least one support cylinder arranged in and/or on the connecting rod, and a support piston movable in said cylinder, having a piston rod in operative connection with the adjusting element;
a first adjustment position of the adjusting element corresponds to a first compression ratio and at least one second adjustment position of the adjusting element corresponds to a second compression ratio higher than the first compression ratio; and
an oil lubrication system for supplying the rotary bearing and/or at least one rotary bearing of the connecting rod with oil;
the oil lubrication system has an oil pump and a control unit, the control unit controls the oil pump for the purpose of producing an oil pressure variable in accordance with the operating mode;
the oil lubrication system is in fluid connection with the support cylinder of the support- and adjustment influencing unit;
the control unit activates the oil pump of the oil lubrication system in order to provide oil to be fed to the support cylinder at a pressure that is modified relative to the oil pressure currently required to supply the rotary bearing and/or the rotary bearings of the connecting rod, more specifically for the purpose of assisting the adjustment of the adjusting element out of the first adjustment position in the direction of and/or into the second adjustment position and/or for the purpose of damping or throttling the adjustment and/or the speed of adjustment of the adjusting element out of the second adjustment position in the direction of and/or into the first adjustment position.

2. The reciprocating-piston machine according to claim 1, wherein the control unit, when required, activates the oil pump of the oil lubrication system in order to provide oil to be fed to the support cylinder at a pressure that is raised relative to the oil pressure currently required to supply the rotary bearing and/or the rotary bearings of the connecting rod for the purpose of assisting the adjustment of the adjusting element out of the first adjustment position in the direction of and/or into the second adjustment position and/or for the purpose of damping or throttling the adjustment and/or the speed of adjustment of the adjusting element out of the second adjustment position in the direction of and/or into the first adjustment position.

3. The reciprocating-piston machine according to claim 1, wherein the oil pump can be activated by the control unit in order to increase the oil pressure for the purpose of assisting the adjustment of the adjusting element out of the first adjustment position in the direction of and/or into the second adjustment position, more specifically can be activated in a manner substantially independent of the oil pressure required, on the basis of the current operating mode, for lubricating and/or cooling the bearing or bearings of the connecting rod.

4. The reciprocating-piston machine according to claim 1, wherein the oil pump can be activated by the control unit to increase the oil pressure for the purpose of throttling the speed of the adjustment of the adjusting element out of the second adjustment position in the direction of and/or into the first adjustment position when the operating mode is that of a part- or full-load mode at relatively low speeds of revolution or that of some other load mode which is close to the operating mode in which a lower compression ratio is sufficient or desirable or in which a switch to a lower compression ratio should take place.
